(19) United States
(12) Patent Application Publication
(10) Pub. No.: US 2024/0412505 A1
(43) Pub. Date: Dec. 12, 2024

(54) IMAGE ANALYSIS SYSTEM, IMAGE ANALYSIS METHOD, AND NON-TRANSITORY COMPUTER-READABLE MEDIUM

(71) Applicant: NEC Coroporation, Minato-ku, Tokyo (JP)

(72) Inventor: Yaeko YONEZAWA, Tokyo (JP)

(73) Assignee: NEC Corporation, Minato-ku, Tokyo (JP)

(21) Appl. No.: 18/697,057

(22) PCT Filed: Oct. 12, 2021
(86) PCT No.: PCT/JP2021/037743

§ 371 Date: Mar. 29, 2024

(51) Int. Cl. G06V 10/98; G06V 10/74

(52) U.S. Cl. CPC G06V 10/98; G06V 10/761

(57) ABSTRACT

An image analysis system (1) includes a product identification result acquisition unit (110) and a correction necessity assessment unit (120). The product identification result acquisition unit (110) acquires an identification result of each of a plurality of products captured in an image. The correction necessity assessment unit (120) computes a first matching degree being a matching degree between an image region of a first product and an image region of a second product when the identification result of the first product among the plurality of products differs from the identification result of the second product adjacent to the first product. Further, the correction necessity assessment unit (120) assesses correction necessity of the identification result of the first product or the identification result of the second product, based on the first matching degree.

### TECHNICAL FIELD

The present invention relates to a technique for identifying a product by using an image.

### BACKGROUND ART

There is known a technique for executing image processing on an image of a place where a product, such as a product in a store, is displayed and identifying the product displayed at the place. In such a technique, product identification may fail, or a product may be erroneously identified due to various factors. Thus, there has been desired a technique for improving accuracy of product identification.

One example of a technique for improving accuracy of product identification is disclosed in Patent Document 1 given below, for example. Patent Document 1 discloses a technique of detecting a product region of each product from an image of a product shelving unit on which a plurality of products are arranged, and assessing validity of a product recognition result relating to the product region as a target, based on relevance between product recognition results of the product region as a target and an adjacent product region.

### RELATED DOCUMENT

### Patent Document

Patent Document 1: International Patent Publication No. WO2019/107157

### SUMMARY OF INVENTION

### Technical Problem

Basically, image-based processing requires a large computational volume. Thus, when an entire image is subjected to image processing for improving accuracy of product identification, a processing time may be increased and exceed an acceptable range.

The present invention has been made in view of the above-mentioned problem. One of objects of the present invention is to provide a technique for improving accuracy of product identification using an image while suppressing an overall processing volume.

### Solution to Problem

An image analysis system according to the present disclosure includes:
a product identification result acquisition unit that acquires an identification result of each of a plurality of products captured in an image; and
a correction necessity assessment unit that computes a first matching degree being a matching degree between an image region of a first product among the plurality of products and an image region of a second product adjacent to the first product when the identification result of the first product differs from the identification result of the second product, and assesses correction necessity of the identification result of the first product or the identification result of the second product, based on the first matching degree.

An image analysis method according to the present disclosure includes, by a computer:
acquiring an identification result of each of a plurality of products captured in an image;
computing a first matching degree being a matching degree between an image region of a first product among the plurality of products and an image region of a second product adjacent to the first product when the identification result of the first product differs from the identification result of the second product; and
assessing correction necessity of the identification result of the first product or the identification result of the second product, based on the first matching degree.

A program according to the present disclosure causes a computer to execute the above-mentioned image analysis method.

### Advantageous Effects of Invention

According to the present invention, it is possible to improve accuracy of product identification using an image while suppressing an overall processing volume.

### BRIEF DESCRIPTION OF DRAWINGS

FIG. 1 It is a diagram illustrating a functional configuration of an image analysis system according to a first example embodiment.

FIG. 2 It is a block diagram illustrating a hardware configuration of an information processing apparatus including each of functional configuration units of the image analysis system.

FIG. 3 It is a flowchart illustrating a flow of processing executed by the image analysis system of the first example embodiment.

FIG. 4 It is a diagram illustrating one example of an image supplied as a processing target to the image analysis system.

FIG. 5 It is a diagram illustrating an image region of each of products captured in the image in FIG. 4.

FIG. 6 It is a diagram illustrating one example of an identification result of each of a plurality of products captured in the image in FIG. 4.

FIG. 7 It is a diagram illustrating a functional configuration of an image analysis system according to a second example embodiment.

FIG. 8 It is a flowchart illustrating a flow of processing executed by the image analysis system of the second example embodiment.

FIG. 9 It is a diagram illustrating one example of an image supplied as a processing target to the image analysis system.

FIG. 10 It is a diagram illustrating a detection result of a placement member in the image in FIG. 9.

FIG. 11 It is a diagram illustrating one example of a processing result acquired by a product identification result acquisition unit and a placement member detection unit.

FIG. 12 It is a diagram illustrating a functional configuration of an image analysis system according to a third example embodiment.

FIG. 13 It is a flowchart illustrating a flow of processing executed by the image analysis system of the third example embodiment.

FIG. 14 It is a diagram illustrating one example of information being output from a correction necessity assessment unit of the third example embodiment.

### DESCRIPTION OF EMBODIMENTS

Example embodiments of the present invention are described below with reference to the drawings. Note that, in all the drawings, a similar constituent element is denoted with a similar reference sign, and description therefor will not be repeated as appropriate. Further, unless otherwise particularly described, each block in each of the block diagrams represents a configuration in a function unit instead of a configuration in a hardware unit. Further, a direction of an arrow in the drawings are simply for better understanding of a flow of information. The direction of the arrow in the drawings does not limit a direction of communication (unidirectional communication/bidirectional communication), unless otherwise particularly described.

### First Example Embodiment

### <Functional Configuration Example>

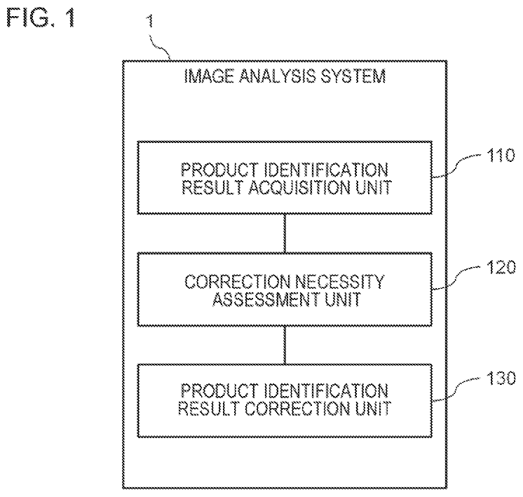

FIG. 1 is a diagram illustrating a functional configuration of an image analysis system according to a first example embodiment. An image analysis system 1 illustrated in FIG. 1 includes a product identification result acquisition unit 110, a correction necessity assessment unit 120, and a product identification result correction unit 130.

The product identification result acquisition unit 110 acquires an image capturing a plurality of products. Further, the product identification result acquisition unit 110 acquires an identification result of each of the plurality of products captured in the image. For example, the product identification result acquisition unit 110 is capable of acquiring an image region associated with each of the products captured in the image and a product identification result of each image region by supplying an acquired image as an input to a product recognition model learnt in advance in such a way as to be able to identify various products. Further, when the acquired image is previously subjected to product recognition processing by an external apparatus, which is omitted in illustration, the product identification result acquisition unit 110 may acquire an image processing result (information indicating an image region of each of the products and a product identification result of each image region) from the external apparatus together with an image being a processing target.

The correction necessity assessment unit 120 assesses whether correction is required for the identification result of each of the products, based on the information acquired by the product identification result acquisition unit 110. Herein, basically, products of the same type are collectively displayed in a store. Thus, it can be said that a feature (exterior feature) of an image region associated with each of the products is similar, except for a place where a product type is actually switched. The correction necessity assessment unit 120 uses such a characteristic, and assesses correction necessity of the identification result by comparing image regions in a section in which the product identification results differ.

First, among the plurality of products captured in the image, the correction necessity assessment unit 120 determines a pair of products that have different product identification results and are adjacent to each other. For example, the correction necessity assessment unit 120 is capable of determining such a pair of products, based on the information acquired by the product identification result acquisition unit 110 (a position of an image region of each of the products and a product identification result of each image region). In the following description, for the sake of convenience, one product forming the pair is also referred to as a “first product”, and the other is also referred to as a “second product”. Further, when an identification result of the first product and an identification result of the second product differ, the correction necessity assessment unit 120 computes a matching degree between an image region associated with the first product and an image region associated with the second product. For example, the correction necessity assessment unit 120 is capable of computing a matching degree of the image regions by extracting various feature values from each of the image regions and comparing the feature values extracted from each of the image regions. In the following description, the matching degree computed herein is also referred to as a “first matching degree”. Further, the correction necessity assessment unit 120 assesses correction necessity of the identification result of the first product or the identification result of the second product, based on the first matching degree being computed.

Herein, as described above, it can be said that a feature of an image region associated with each of the products is similar, except for a place where a product type is actually switched. Thus, when the first matching degree is equal to or greater than a reference value for deciding that “both the products are similar”, it is conceivable that the first product and the second product are actually identical products, and any one of the identification result of the first product and the identification result of the second product is possibly incorrect. Thus, in this case, the correction necessity assessment unit 120 assesses that correction is required for the identification result of the first product or the identification result of the second product. On the other hand, when the first matching degree is less than the reference value for deciding that “both the products are similar”, it is conceivable that the first product and the second product are actually different products, and the identification result of the first product and the identification result of the second product are less likely to be incorrect. Thus, in this case, the correction necessity assessment unit 120 assesses that correction is not required for the identification result of the first product or the identification result of the second product.

As described above, the product identification result correction unit 130 corrects one of the identification result of the first product and the identification result of the second product, in response to decision indicating necessity of correction of the identification result of the first product or the identification result of the second product, the decision being made based on the first matching degree. A specific method is described below, and the product identification result correction unit 130 causes any one of the identification results of the first product and the second product to match with the other identification result.

### <Hardware Configuration of Image Analysis System 1>

Each of functional configuration units of the image analysis system 1 may be achieved by hardware achieving each of the functional configuration units (example: a hard-wired electronic circuit), or may be achieved by a combination of hardware and software (example: a combination of an electronic circuit and a program controlling the same). Description is further made below in a case in which each of the functional configuration units of the image analysis system 1 is achieved by a combination of hardware and software in one information processing apparatus.

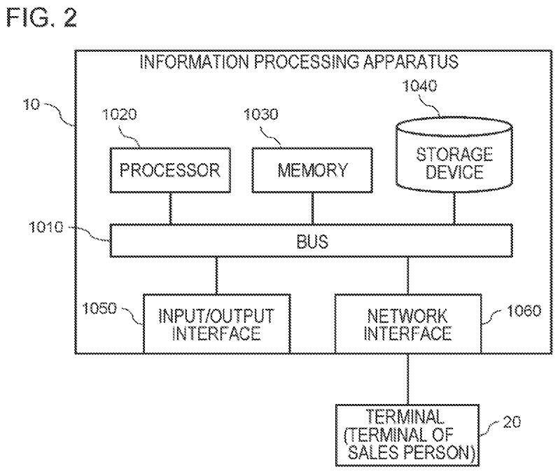

FIG. 2 is a block diagram illustrating a hardware configuration of an information processing apparatus 10 including each of the functional configuration units of the image analysis system 1. The information processing apparatus 10 includes a bus 1010, a processor 1020, a memory 1030, a storage device 1040, an input/output interface 1050, and a network interface 1060.

The bus 1010 is a data transmission path in which the processor 1020, the memory 1030, the storage device 1040, the input/output interface 1050, and the network interface 1060 transmit and receive data mutually. However, a method of connecting the processor 1020 and the like to one another is not limited to bus connection.

The processor 1020 is a processor achieved by a central processing unit (CPU), a graphics processing unit (GPU), or the like.

The memory 1030 is a main storage apparatus achieved by a random access memory (RAM), or the like.

The storage device 1040 is an auxiliary storage apparatus achieved by a hard disk drive (HDD), a solid state drive (SSD), a memory card, a read only memory (ROM), or the like. The storage device 1040 stores a program module for achieving each of functions of the image analysis system 1 described in the present specification. The processor 1020 reads the program module on the memory 1030 and executes the program module, and thereby each of the functions (the product identification result acquisition unit 110, the correction necessity assessment unit 120, the product identification result correction unit 130, and the like) of the image analysis system 1 described in the present specification is achieved.

The input/output interface 1050 is an interface for connecting the information processing apparatus 10 and peripheral equipment to each other. The input/output interface 1050 may be connected to an input apparatus such as a keyboard, a mouse, and a touch panel, and an output apparatus such as a display and a speaker.

The network interface 1060 is an interface for connecting the information processing apparatus 10 to a network. For example, the network is a local area network (LAN) or a wide area network (WAN). A method of connecting to the network via the network interface 1060 may be wireless connection or wired connection. In one example, the information processing apparatus 10 can communicate with a terminal 20 carried by a sales person or another external apparatus that are connected to the network via the network interface 1060.

Note that, the hardware configuration illustrated in FIG. 2 is merely one example. The hardware configuration of the image analysis system 1 according to the present disclosure is not limited to the example in FIG. 2. For example, the various functions of the image analysis system 1 according to the present disclosure may be implemented in a single information processing apparatus, or may be implemented in a plurality of information processing apparatuses in a distributed manner. Further, in the example in FIG. 2, the information processing apparatus 10 including each of the functions of the image analysis system 1 is illustrated as an apparatus different from the terminal 20 used by a sales person, but all or some of the functions of the image analysis system 1 may be included in the terminal 20 used by a sales person.

### <Flow of Processing>

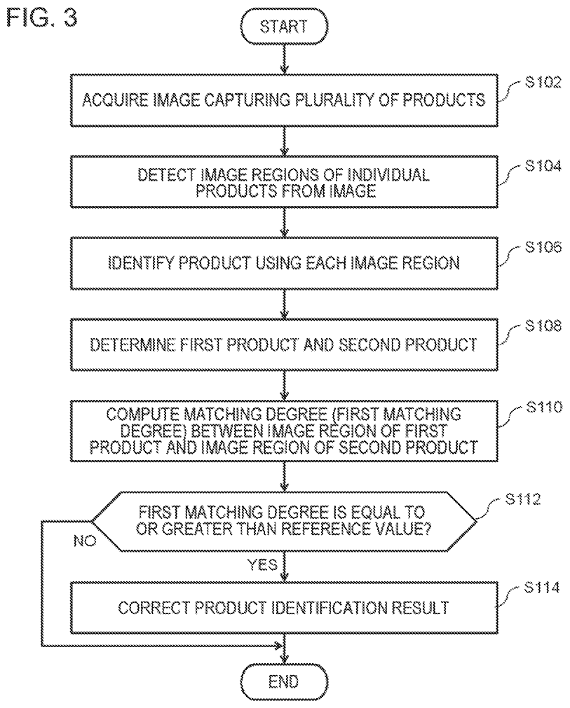

FIG. 3 is a flowchart illustrating a flow of processing executed by the image analysis system 1 of the first example embodiment.

First, the product identification result acquisition unit 110 acquires an image of a product captured by an imaging apparatus, which is omitted in illustration, as an image being a processing target (S102). For example, an image of a product is captured by a camera mounted to a terminal (for example, the terminal 20 illustrated in FIG. 2) carried by a sales person. For example, a sales person captures an image of a place where a product is displayed (a product shelving unit, or the like), by using a camera function of the terminal. The product identification result acquisition unit 110 may acquire an image of a product from the terminal or a server apparatus for collecting and accumulate images generated by the terminal, which is omitted in illustration.

Further, the product identification result acquisition unit 110 extracts an image region associated to an individual object (product) from the acquired image (S104). For example, the product identification result acquisition unit 110 is capable of recognizing an individual object (an object assumed to be a product of some sort) in the image by using an object recognition model (omitted in illustration) learnt by a machine learning algorithm such as Deep Learning. “Recognition” referred herein includes determination of a position of an image region associated with an object (example: position coordinates in an image coordinate system). In one example, for example, the object recognition model is stored in advance in the storage device 1040 of the information processing apparatus 10 in FIG. 2. In another example, the object recognition model may be stored in an external apparatus (omitted in illustration) being communicably connected to the information processing apparatus 10 in FIG. 2 via the network interface 1060.

Further, the product identification result acquisition unit 110 identifies a product associated with each of the extracted image regions by using each of the image regions (S106). For example, the product identification result acquisition unit 110 generates image feature information from each of the image regions by using a known method, and computes a similarity degree between the image feature information generated from each of the image regions and master information (feature information to be compared at a time of identifying each of the products) relating to each of the products. Note that, for example, the master information relating to each of the products is stored in the storage device 1040 of the information processing apparatus 10 in FIG. 2 or an external storage apparatus (omitted in illustration) communicably connected via the network interface 1060. Further, the product identification result acquisition unit 110 identifies a product associated with each of the image regions, based on the similarity degree computed by using the image feature information relating to each of the image regions.

Note that, the above-mentioned processing in S104 and S106 may be executed by an external apparatus, which is omitted in illustration. In this case, in the processing in S102, the product identification result acquisition unit 110 acquires an image being a processing target and a processing result of the image (information including a detection position of an image region of each of products in the image and a product identification result of each image region) from the external apparatus.

The correction necessity assessment unit 120 determines a first product and a second product that are processing targets, based on the position of each of the image regions and the product identification result associated with each of the image regions (S108). For example, the correction necessity assessment unit 120 compares product identification results in two image regions adjacent to each other in any of vertical and horizontal directions. When the product identification results differ in the two image regions, the correction necessity assessment unit 120 is capable of determining each of the two image regions as the image regions associated with the first product and the second product that are processing targets.

Further, the correction necessity assessment unit 120 computes a matching degree (a first matching degree) between the two image regions being determined, that is, the image region of the first product and the image region of the second product (S110). For example, the correction necessity assessment unit 120 extract various pieces of image feature information that may indicate an exterior feature of a product, from each of the image regions by using a known method. Further, the correction necessity assessment unit 120 computes the first matching degree relating to the two image regions, by comparing the image feature information extracted from the image region of the first product and the image feature information extracted from the second image region with each other.

Further, the correction necessity assessment unit 120 assesses whether the first matching degree computed in the processing in S110 is equal to or greater than a predetermined reference value (S112). The predetermined reference value is a value indicating a reference for deciding that objects (products) captured in the image regions are identical to each other in an exterior sense, and is set to an appropriate value in advance. For example, the predetermined reference value is set in advance in the memory 1030 or the storage device 1040 of the information processing apparatus 10 in FIG. 2. With reference to the reference value, the correction necessity assessment unit 120 may assess whether the matching degree computed in S110 is equal to or greater than the reference value.

When the first matching degree computed in the processing in S110 is less than the predetermined reference value (S112: NO), it is highly possible that the first product and the second product are actually different products. In this case, the correction necessity assessment unit 120 decides that there is no need for correction, and processing in S114 described later is not executed. On the other hand, when the first matching degree computed in the processing in S110 is equal to or greater than the predetermined reference value (S112: YES), it is highly possible that the first product and the second product are actually identical products, and it can be said that any one of the identification results is incorrect. Thus, the correction necessity assessment unit 120 decides that there is need for correction. In this case, the product identification result correction unit 130 corrects the identification result relating to the first product and the identification result relating to the second product (S114).

The above-mentioned processing is described more specifically with reference to the drawings. Note that, the processing described below is merely one example, and processing of the image analysis system 1 according to the present disclosure is not limited to a content described below.

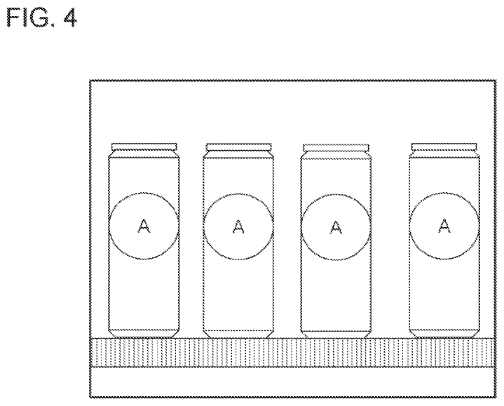

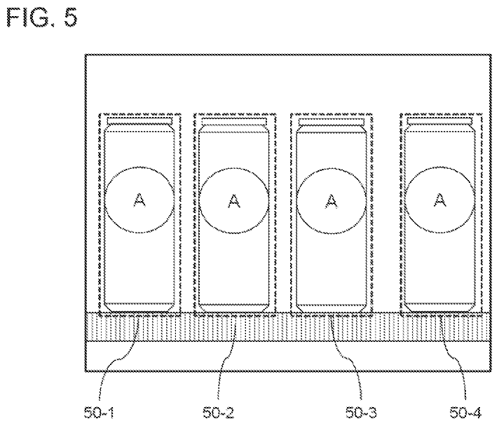

FIG. 4 is a diagram illustrating one example of an image supplied as a processing target to the image analysis system 1. When an image as illustrated in FIG. 4 is acquired, the product identification result acquisition unit 110 detects an image region associated with each object (product) in the image by using, for example, an object recognition model stored in the storage device 1040 of the information processing apparatus 10 in FIG. 2 or the like, as illustrated in FIG. 5.

FIG. 5 is a diagram illustrating an image region of each of the products captured in the image in FIG. 4. The product identification result acquisition unit 110 determines a plurality of image regions in the image, as indicated with dashed rectangles in FIG. 5. Note that, when each of the image regions is distinguished from one another in the following description, reference signs 50-1 to 50-4 are used as illustrated. In this state, for example, the product identification result acquisition unit 110 generates information indicating a shape of an image region (example: position information relating to each vertex in the image and information indicating connection between the vertexes) for each of image regions 50-1 to 50-4, and stores the generated information in a predetermined storage region (example: the storage device 1040 of the information processing apparatus 10 in FIG. 2). Based on the information thus stored, the correction necessity assessment unit 120 is capable of determining a positional relationship of the image regions associated with each of a plurality of objects (products) in the image.

Further, the product identification result acquisition unit 110 generates the image feature information for each of the plurality of image regions detected as illustrated in FIG. 5, and identifies a product associated with each of the regions by using the image feature information relating to each of the plurality of image regions. For example, for each of the plurality of image regions, the product identification result acquisition unit 110 is capable of comparing the image feature information with master information relating to each of the products with each other, and determining a most similar product, based on the comparison result (the matching degree with respect to the master information). The product identification result acquisition unit 110 stores, in the predetermined storage region (example: the storage device 1040 of the information processing apparatus 10 in FIG. 2), a product result identified by using each of the image regions, in association with the above-mentioned information indicating the position of each of the image regions.

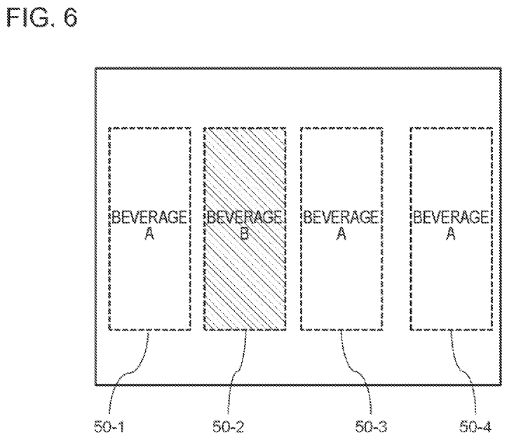

Further, for example, the correction necessity assessment unit 120 compares product identification results between two adjacent image regions sequentially from a left side of the image by using the results acquired from the processing by the product identification result acquisition unit 110. Herein, for example, as a result of the processing by the product identification result acquisition unit 110, it is assumed that information as illustrated in FIG. 6 is acquired. FIG. 6 is a diagram illustrating one example of an identification result of each of a plurality of products captured in the image in FIG. 4. In the example in FIG. 6, only the product in the image region 50-2 is identified as “beverage B”, and the products in all the other image regions are identified as “beverage A”. In this case, first, the correction necessity assessment unit 120 may determine a pair of the image region 50-1 and the image region 50-2 as a processing target, based on the positional relationship between the image region 50-1 and the image region 50-2 and the identification result of each of the products in the regions. Further, the correction necessity assessment unit 120 computes the first matching degree between the image region 50-1 and the image region 50-2, the first matching degree indicating a matching degree between the image regions (exterior features of the products).

When the first matching degree is equal to or greater than a reference, the correction necessity assessment unit 120 recognizes that the product in the image region 50-1 and the product in the image region 50-2 are identical products, and assesses that correction for the product identification result is required. In this case, the correction necessity assessment unit 120 requests the product identification result correction unit 130 to execute correction processing. On the other hand, when the first matching degree is less than a reference value, the correction necessity assessment unit 120 recognizes that the product in the image region 50-1 and the product in the image region 50-2 are different products, and assesses that correction for the product identification result is not required. Herein, with reference to FIG. 5, the products placed at the positions associated with the image region 50-1 and the image region 50-2 are actually identical products (beverage A). Thus, the correction necessity assessment unit 120 may find a relatively large number of similarities regarding the image regions (exterior features of the products) between the image region 50-1 and the image region 50-2. As a result, the first matching degree, which is equal to or greater than the reference value, between the image region 50-1 and the image region 50-2 is computed, and it is estimated that the correction necessity assessment unit 120 assesses that correction is required for the product identification result of the image region 50-1 or the product identification result of the image region 50-2.

In response to the request from the correction necessity assessment unit 120, the product identification result correction unit 130 corrects a product identification result of one of two image regions being targets. In one example, the product identification result correction unit 130 is capable of acquiring a matching degree with respect to the master information, which is used for identifying a product in each of image regions, as a second matching degree, and deciding an identification result for the image region with a higher second matching degree as the product identification result of the two image regions. For example, the product identification result correction unit 130 may acquire a matching degree (second matching degree) with respect to master information relating to a product “beverage A” for the image region 50-1, based on a result of product identification processing by the product identification result acquisition unit 110. Similarly, the product identification result correction unit 130 may acquire a matching degree (second matching degree) with respect to master information relating to a product “beverage B” for the image region 50-2, based on a result of product identification processing by the product identification result acquisition unit 110. Further, the product identification result correction unit 130 may compare image feature information acquired from the image regions with the master information relating to the product identified by the product identification result acquisition unit 110, and recompute the matching degree (second matching degree). Further, when the second matching degree relating to the image region 50-1 is higher than the second matching degree relating to the image region 50-2, the product identification result acquisition unit 110 corrects the product identification result (beverage A) of the image region 50-1 to an identification result (beverage A) identical to the product identification result of the image region 50-2. On the other hand, when the second matching degree relating to the image region 50-2 is higher than the second matching degree relating to the image region 50-1, the product identification result acquisition unit 110 corrects the product identification result (beverage A) of the image region 50-1 to an identification result (beverage B) identical to the product identification result of the image region 50-2. Note that, as illustrated in FIG. 5, the products placed at the positions associated with each of the image region 50-1 and the image region 50-2 are actually “beverage A”. Thus, it is estimated that the second matching degree relating to the image region 50-1 (the matching degree with respect to the master information relating to “beverage A”) is higher than the second matching degree relating to the image region 50-2 (the matching degree with respect to the master information relating to “beverage B”) and the product identification result correction unit 130 corrects the product identification result of the image region 50-2 from “beverage B” to “beverage A”.

In another example, the product identification result correction unit 130 may use information relating to a product in the image region 50-3 that is adjacent to the product in the image region 50-2 at a position different from the product in the image region 50-1 and has an identification result identical to that of the image region 50-1. In this case, first, the product identification result correction unit 130 computes a matching degree between the image region 50-2 and the image region 50-3 as the second matching degree. When the second matching degree is equal to or greater than the reference value, it is highly possible that the product in the image region 50-2 and the product in the image region 50-3 are actually identical products. Herein, as a result of the assessment based on the first matching degree by the correction necessity assessment unit 120, it is highly possible that the product in the image region 50-1 and the product in the image region 50-2 are also actually identical products. Therefore, the product identification result correction unit 130 can decide that the identical products are arranged side by side from the image region 50-1 to the image region 50-3. In this case, for example, based on the fact that the product identification result indicating “beverage A” is frequently acquired in a range in which the identical products are arranged side by side, the product identification result correction unit 130 corrects the product identification result “beverage B” of the image region 50-2 to the product identification result “beverage A”.

### Example of Advantageous Effect

In this manner, accuracy of product identification using an image can be improved by comparing image regions of two products displayed nearby and assessing whether the products are identical. Further, when a target is narrowed to a section in which two products having different identification results are adjacent to each other, reduction of an overall processing volume can be expected in processing for improving accuracy of product identification.

### Second Example Embodiment

The present example embodiment includes a configuration similar to that in the first example embodiment, except for the matters described below.

### <Functional Configuration>

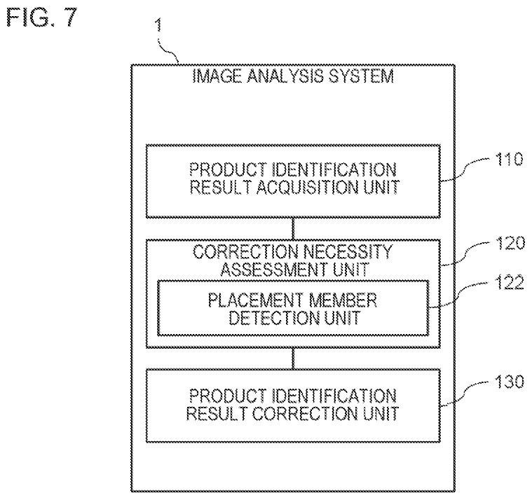

FIG. 7 is a diagram illustrating a functional configuration of an image analysis system according to a second example embodiment. In the present example embodiment, a correction necessity assessment unit 120 further includes a placement member detection unit 122. The placement member detection unit 122 acquires information indicating an image region of a placement member (example: a shelf board of a product shelving unit) on which a product is placed.

Herein, in general, a product shelving unit includes a plurality of shelf boards, and different types of products are arranged on respective shelf boards in most cases. Thus, even when different identification results are acquired for two products that establish a positional relationship of being adjacent to each other with a shelf board interposed therebetween in a vertical direction, it is highly possible that the identification result of each of the products is correct. Meanwhile, identical products may be displayed in a stacking manner in the vertical direction on the shelf boards. In such a region in which identical products are displayed in a stacking manner in the vertical direction, when different identification results are acquired for two products that establish a positional relationship of being adjacent to each other in the vertical direction, it is highly possible that the identification results are incorrect.

The correction necessity assessment unit 120 of the present example embodiment is configured to be capable of recognizing a region in which products are stacked in the vertical direction (hereinafter, also referred to as a “stacking region”). Specifically, the correction necessity assessment unit 120 determines a position of a placement member in an image being a processing target, based on information acquired by the placement member detection unit 122. Determination of the position of the placement member in the processed image enables the correction necessity assessment unit 120 to assess the stacking region, based on a positional relationship between an image region associated with each of the products and an image region of the placement member. Further, the correction necessity assessment unit 120 is given priority in checking a direction orthogonal to the placement member (a product stacking direction), and determines a first product and a second product. When there are two products adjacent to each other without the placement member being interposed therebetween, the correction necessity assessment unit 120 is given priority in determining the two products as the first product and the second product.

### <Flow of Processing>

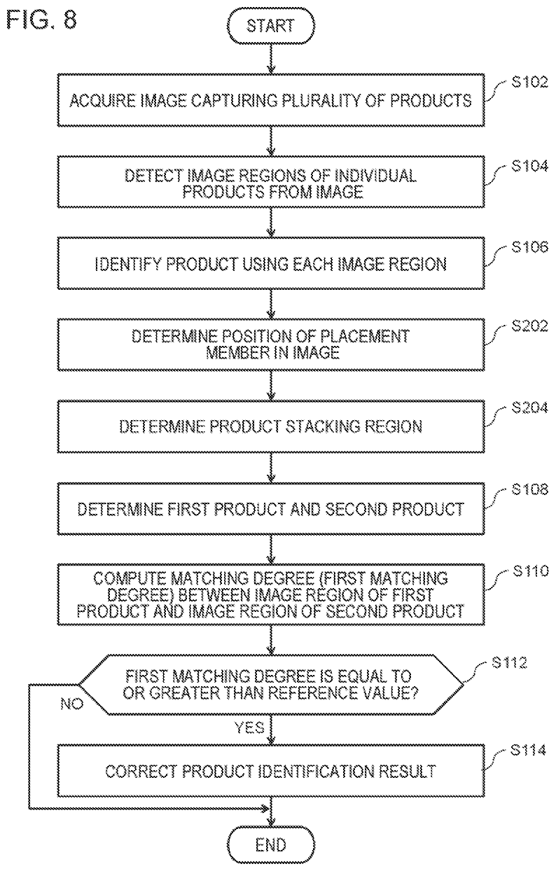

FIG. 8 is a flowchart illustrating a flow of processing executed by an image analysis system 1 of the second example embodiment. The matter being different from the flowchart in FIG. 3 is mainly described below.

Before determining a first product and a second product that are processing targets, the correction necessity assessment unit 120 determines a position of a placement member in an image (S202). For example, the placement member detection unit 122 is capable of detecting a region of the placement member from the image being a processing target, by using a machine learning model capable of detecting a region of a product placement member (shelf board). Such a machine learning model is constructed by training using learning data provided in advance with information indicating a region of a product placement member, and is stored in a storage device 1040 of an information processing apparatus 10 in FIG. 2.

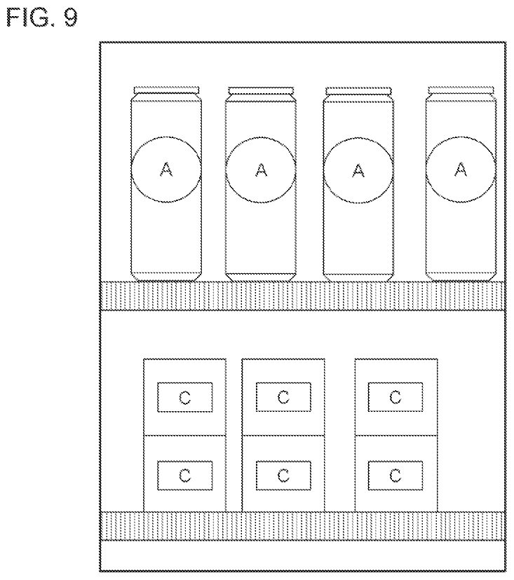

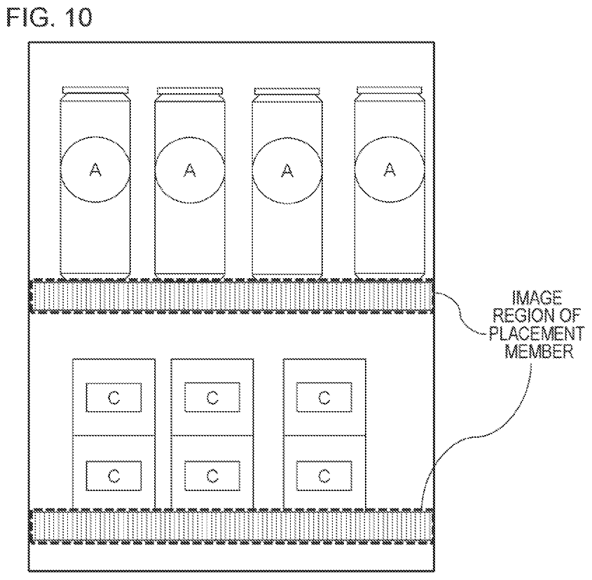

For example, it is assumed that an image illustrated in FIG. 9 is supplied as a processing target to the image analysis system 1. FIG. 9 is a diagram illustrating one example of an image supplied as a processing target to the image analysis system 1. The placement member detection unit 122 is capable of acquiring a result as illustrated in FIG. 10 by using the above-mentioned machine learning model, for example. FIG. 10 is a diagram illustrating a detection result of the placement member in the image in FIG. 9. The placement member detection unit 122 acquires positional information relating to image regions surrounded by dashed lines in FIG. 10, and stores the acquired information in a memory 1030 or the storage device 1040 of the information processing apparatus 10, for example. The correction necessity assessment unit 120 is capable of determining the position of the placement member in the image, based on the stored information.

The correction necessity assessment unit 120 determines a stacking region in the image (S204), based on the positional information relating to the image region of the placement member being acquired in the processing in S202 and positional information relating to an image region of each of the products being acquired in processing in S104. The correction necessity assessment unit 120 is capable of detecting the region (stacking region) in which a plurality of products are adjacent to each other without the placement member being interposed therebetween in the vertical direction, based on the vertical positional information relating to each of the image regions being acquired by a product identification result acquisition unit 110 and the placement member detection unit 122.

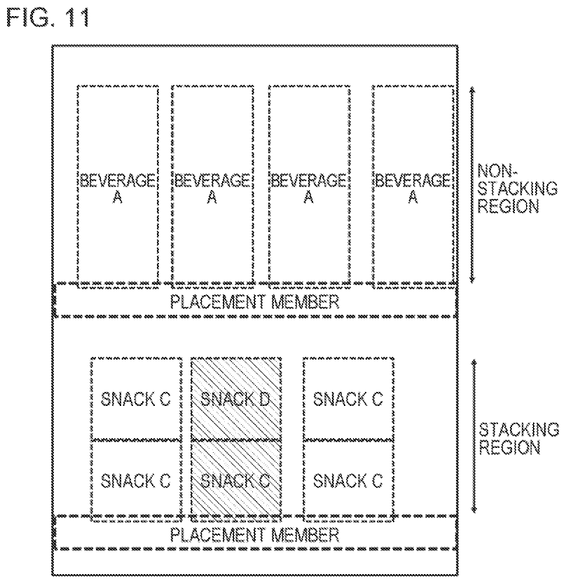

For example, it is assumed that, as a result of the processing by the product identification result acquisition unit 110 and the placement member detection unit 122, a processing result illustrated in FIG. 11 is acquired. FIG. 11 is a diagram illustrating one example of a processing result acquired by the product identification result acquisition unit 110 and the placement member detection unit 122. When the processing result as illustrated in FIG. 11 is acquired, there is only one image region of a product on an upper placement member in a direction orthogonal to the placement member. In this case, the correction necessity assessment unit 120 is capable of assessing a region above the upper placement member as a region (non-stacking region) in which the products are not stacked. On the other hand, there are two image regions of products on a lower placement member without the placement member interposed therebetween in the direction orthogonal to the placement member. In this case, the correction necessity assessment unit 120 is capable of assessing a region between the upper placement member and the lower placement member as a region (stacking region) in which the plurality of products are stacked.

Further, as described in the first example embodiment, the correction necessity assessment unit 120 determines the first product and the second product (S108). Note that, in the stacking region determined in S204, the correction necessity assessment unit 120 examines the product identification results along a product stacking direction (vertical direction), and determines the first product and the second product. In the example in FIG. 11, different product identification results are acquired for two image regions indicated by oblique lines. In this case, the correction necessity assessment unit 120 determines two products associated with the image regions as the first product and the second product. On the other hand, in the region (non-stacking region) other than the stacking region, the correction necessity assessment unit 120 determines the first product and the second product, based on a comparison result in a horizontal direction.

Further, the correction necessity assessment unit 120 requests a product identification result correction unit 130 to correct the product identification result, based on the matching degree between the image region of the determined first product and the determined second product (S110, S112). In response to the request from the correction necessity assessment unit 120, the product identification result correction unit 130 corrects one of the identification result of the first product and the identification result of the second product (S114). The processing is similar to the processing described in the first example embodiment.

In the present example embodiment, a region (stacking region) in which products are displayed in a stacking manner is determined by detecting a product placement member. Further, in the stacking region, it is assessed whether product identification results differ along a direction in which the products are stacked. Herein, basically, the identical products are displayed in a stacking manner. Thus, a section where a product is incorrectly identified can be detected efficiently by comparing the product identification results in the stacking region along a product stacking direction.

### Third Example Embodiment

### <Functional Configuration>

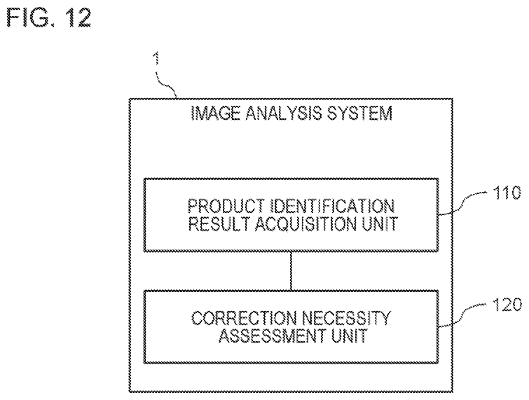

FIG. 12 is a diagram illustrating a functional configuration of an image analysis system according to a third example embodiment. An image analysis system 1 of the present example embodiment includes a configuration similar to that of the first or second example embodiment, except that a product identification result correction unit 130 is not provided. In other words, a product identification result acquisition unit 110 and a correction necessity assessment unit 120 of the present example embodiment include functions similar to those described in the first or second example embodiment.

### <Hardware Configuration>

The image analysis system 1 of the present example embodiment may be achieved by a hardware configuration similar to that in the first or second example embodiment (example: FIG. 2). For example, a storage device 1040 in FIG. 2 stores a program module achieving a function, including the product identification result acquisition unit 110 and the correction necessity assessment unit 120, of the image analysis system 1. A processor 1020 in FIG. 2 reads each of the program modules on a memory 1030 and executes the program module, and thereby the function associated with the read program module is achieved.

### <Flow of Processing>

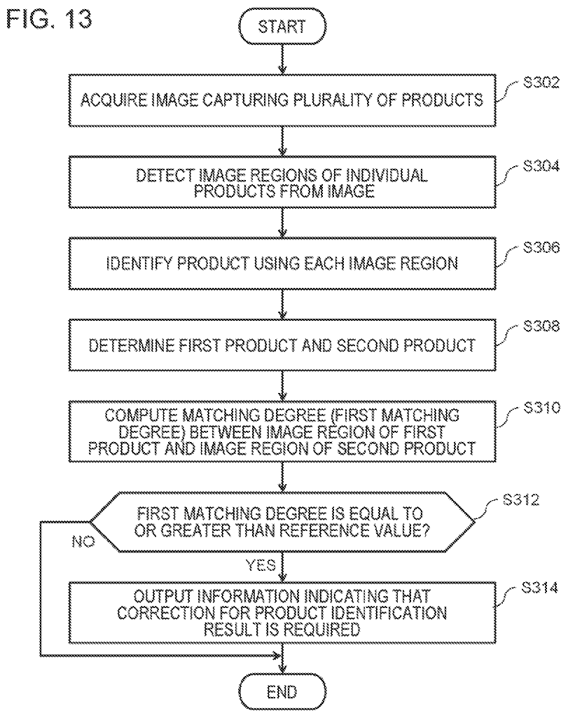

FIG. 13 is a flowchart illustrating a flow of processing executed by the image analysis system 1 of the third example embodiment. Processing from S302 to S312 in the flowchart in FIG. 13 is similar to the processing from $102 to S112 in FIG. 3. The processing different from that in the first and second example embodiments is mainly described below. Note that, although omitted in illustration, the image analysis system 1 of the present example embodiment may be configured to further execute the processing described in the second example embodiment (example: the processing in S202 and S204 in the flowchart in FIG. 8).

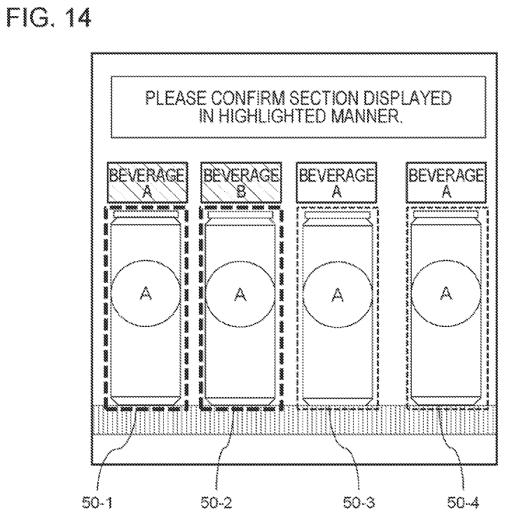

As described in the first example embodiment, when different identification results are acquired for two adjacent image regions, the correction necessity assessment unit 120 determines the two image regions as image regions associated with a first product and a second product that are processing targets (S308). Further, when a first matching degree being computed by comparing the two image regions being determined is equal to or greater than a predetermined reference value (S312: YES), the correction necessity assessment unit 120 decides that correction for the product identification result is required. In this case, the correction necessity assessment unit 120 outputs information indicating that correction for the product identification result is required (S314). For example, the correction necessity assessment unit 120 outputs, to a processing unit (omitted in illustration in the present example embodiment) being equivalent to the product identification result correction unit 130, the information indicating that correction for the product identification result is required. As a result, as described in the other example embodiments, the product identification result being possibly incorrect is corrected. Further, the correction necessity assessment unit 120 may output the information indicating that correction for the product identification result is required to a screen of a terminal 20 of a sales person, for example. For example, it is assumed that an image as illustrated in FIG. 4 is supplied as an input image and information as illustrated in FIG. 6 is acquired as the identification results of a plurality of products captured in the image. In this case, the correction necessity assessment unit 120 of the present example embodiment may be configured to output information as illustrated in FIG. 14.

FIG. 14 is a diagram illustrating one example of information output from the correction necessity assessment unit 120 of the third example embodiment. In the example in FIG. 14, the identification result of the first product (beverage A) being positioned on a far left side of an input image and the identification result of the second product (beverage B) being positioned as the second to the left in the input image are different from each other, and hence the correction necessity assessment unit 120 determines the two image regions (an image region 50-1 and an image region 50-2) associated with the products as processing targets. Herein, when a matching degree between the image region 50-1 and the image region 50-2 is equal to or greater than a reference, the correction necessity assessment unit 120 changes a display mode of the image region or the product identification result relating to the image region, as illustrated. Specifically, the correction necessity assessment unit 120 displays a frame or a background indicating the image region in a highlighted manner, or displays the identification result of the image region in the highlighted manner. Further, the correction necessity assessment unit 120 may output a message for encouraging a user to confirm the product identification results of the two image regions that are processing targets.

Further, the image analysis system 1 may further include a function of receiving an input of information for correcting a product identification result from a user. For example, when the image illustrated in FIG. 14 is displayed on the screen of the terminal 20 of a sales person, a sales person who uses the terminal 20 performs an input operation of selecting an image region being a target, by using an input device of the terminal 20. In response to the sales person performing the input operation of selecting the image region, the image analysis system 1 displays a form on the screen for inputting information in order to correct the product identification result of the selected image region. Further, when the sales person inputs information for correction (correct product identification result) in the form displayed on the screen, the product identification result of the selected image region is corrected. For example, a sales person can decide that, based on the image in FIG. 14, the product identification result of the image region 50-2 is incorrect. In this case, the sales person can select the image region 50-2 as a target, and perform an input in order to correct the product identification result to “beverage A”. As a result, the product identification result (beverage B) associated with the image region 50-2 in FIG. 14 is corrected to the product identification result (beverage A) being input by the sales person.

### Examples of Advantageous Effects

In the present example embodiment, image regions of two products displayed nearby are compared with each other, and information indicating that correction for a product identification result is required is output based on an assessment result acquired by assessing whether the products are identical. As described in the other example embodiments described above, such information can be used as a trigger of processing for improving accuracy of product identification. Further, a target is narrowed to a section in which two products having different identification results are adjacent to each other, and thereby reduction of an overall processing volume can be expected in the processing for improving accuracy of product identification.

### <Other Functions>

Further, when an assessment result acquired by the correction necessity assessment unit 120 is displayed on the screen of a terminal of a sales person, and a sales person performs an input operation of correcting a product identification result, the image analysis system 1 may generate learning data acquired by combining an image region being selected as a target and information (a label indicating correct answer information) being input in correction processing. Such learning data are fed back to a product identification model that generates the product identification result acquired by the product identification result acquisition unit 110, and thereby identification accuracy of the product identification model can also be improved.

While the example embodiments of the present invention are described above with reference to the drawings, the present invention is not limited thereto at a time of interpretation, and various changes, modifications, and the like may be made thereto without departing from the gist of the present invention, based on the knowledge of a person skilled in the art. Further, a plurality of constituent elements disclosed in the example embodiments may be combined with each other as appropriate to form various inventions. For example, some constituent elements may be eliminated from the entire constituent elements indicated in the example embodiments, or the constituent elements of the different example embodiments may be combined with each other as appropriate.

Further, in a plurality of the flowcharts used in the description given above, a plurality of steps (pieces of processing) are described in order, but the execution order of the steps executed in each of the example embodiments is not limited to the described order. In each of the example embodiments, the order of the illustrated steps may be changed without interfering with the contents. Further, the example embodiments and the modification examples described above may be combined with each other within a range where the contents do not conflict with each other.

The whole or a part of the example embodiments described above can be described as, but not limited to, the following supplementary notes.

1.

An image analysis system including:
a product identification result acquisition unit that acquires an identification result of each of a plurality of products captured in an image; and
a correction necessity assessment unit that computes a first matching degree being a matching degree between an image region of a first product among the plurality of products and an image region of a second product adjacent to the first product when the identification result of the first product differs from the identification result of the second product, and assesses correction necessity of the identification result of the first product or the identification result of the second product, based on the first matching degree.
   2.

The image analysis system according to supplementary note 1, further including:
a product identification result correction unit that corrects one of the identification result of the first product and the identification result of the second product in response to assessment indicating necessity of correction of the identification result of the first product or the identification result of the second product, the assessment being made based on the first matching degree.
   3.

The image analysis system according to supplementary note 2, in which
the product identification result correction unit
   acquires a second matching degree indicating a matching degree, for each of the first product and the second product, with master information relating to each product, and
   decides, from the identification results of the first product and the second product, the identification result with the higher second matching degree as an identification result of the first product and the second product.
      4.

The image analysis system according to supplementary note 2, in which
the product identification result correction unit
   computes a second matching degree indicating a matching degree between the image region of the first product and an image region of a third product when the third product is present adjacent to the first product at a position different from the second product and has the identification result identical to that of the second product, and
   corrects the identification result of the first product when the second matching degree is equal to or greater than a reference.
      5.

The image analysis system according to any one of supplementary notes 1 to 4, in which
the correction necessity assessment unit
   acquires information indicating an image region of a placement member that places a product, and
   determines, as the first product and the second product, two products adjacent to each other in a direction orthogonal to the placement member without the placement member being interposed therebetween.
      6.

An image analysis method including,
by a computer:
acquiring an identification result of each of a plurality of products captured in an image:
computing a first matching degree being a matching degree between an image region of a first product among the plurality of products and an image region of a second product adjacent to the first product when the identification result of the first product differs from the identification result of the second product; and
assessing correction necessity of the identification result of the first product or the identification result of the second product, based on the first matching degree.
   7.

The image analysis method according to supplementary note 6, further including,
by the computer,
   correcting one of the identification result of the first product and the identification result of the second product in response to assessment indicating necessity of correction of the identification result of the first product or the identification result of the second product, the assessment being made based on the first matching degree.
      8.

The image analysis method according to supplementary note 7, further including,
by the computer:
   acquiring a second matching degree indicating a matching degree, for each of the first product and the second product, with master information relating to each product; and
   deciding, from the identification results of the first product and the second product, the identification result with the higher second matching degree as an identification result of the first product and the second product.
      9.

The image analysis method according to supplementary note 7, further including,
by the computer:
   computing a second matching degree indicating a matching degree between the image region of the first product and an image region of a third product when the third product is present adjacent to the first product at a position different from the second product and has the identification result identical to that of the second product; and
   correcting the identification result of the first product when the second matching degree is equal to or greater than a reference.
      10.

The image analysis method according to any one of supplementary notes 6 to 9, further including,
by the computer:
   acquiring information indicating an image region of a placement member that places a product; and
   determining, as the first product and the second product, two products adjacent to each other in a direction orthogonal to the placement member without the placement member being interposed therebetween.
      11.

A program causing a computer to execute the image analysis method according to any one of supplementary notes 6 to 10.

### REFERENCE SIGNS LIST

1 Image analysis system
10 Information processing apparatus
1010 Bus
1020 Processor
1030 Memory
1040 Storage device
1050 Input/output interface
1060 Network interface
110 Product identification result acquisition unit
120 Correction necessity assessment unit
122 Placement member detection unit
130 Product identification result correction unit
20 Terminal

What is claimed is:

1. An image analysis system comprising:
at least one memory configured to store instructions; and
at least one processor configured to execute the instructions to perform operations comprising:
acquiring an identification result of each of a plurality of products captured in an image; and
computing a first matching degree being a matching degree between an image region of a first product among the plurality of products and an image region of a second product adjacent to the first product when the identification result of the first product differs from the identification result of the second product, and assessing correction necessity of the identification result of the first product or the identification result of the second product, based on the first matching degree.

2. The image analysis system according to claim 1, wherein the operations further comprise
correcting one of the identification result of the first product and the identification result of the second product in response to assessment indicating necessity of correction of the identification result of the first product or the identification result of the second product, the assessment being made based on the first matching degree.

3. The image analysis system according to claim 2, wherein
the operations further comprise
acquiring a second matching degree indicating a matching degree, for each of the first product and the second product, with master information relating to each product, and
deciding, from the identification results of the first product and the second product, the identification result with the higher second matching degree as an identification result of the first product and the second product.

4. The image analysis system according to claim 2, wherein
the operations further comprise
computing a second matching degree indicating a matching degree between the image region of the first product and an image region of a third product when the third product is present adjacent to the first product at a position different from the second product and has the identification result identical to that of the second product, and
correcting the identification result of the first product when the second matching degree is equal to or greater than a reference.

5. The image analysis system according to claim 1, wherein
the operations further comprise
acquiring information indicating an image region of a placement member that places a product, and
determining, as the first product and the second product, two products adjacent to each other in a direction orthogonal to the placement member without the placement member being interposed therebetween.

6. An image analysis method comprising,
by a computer:
acquiring an identification result of each of a plurality of products captured in an image;
computing a first matching degree being a matching degree between an image region of a first product among the plurality of products and an image region of a second product adjacent to the first product when the identification result of the first product differs from the identification result of the second product; and
assessing correction necessity of the identification result of the first product or the identification result of the second product, based on the first matching degree.

7. The image analysis method according to claim 6, further comprising,
by the computer,
correcting one of the identification result of the first product and the identification result of the second product in response to assessment indicating necessity of correction of the identification result of the first product or the identification result of the second product, the assessment being made based on the first matching degree.

8. The image analysis method according to claim 7, further comprising,
by the computer:
acquiring a second matching degree indicating a matching degree, for each of the first product and the second product, with master information relating to each product; and
deciding, from the identification results of the first product and the second product, the identification result with the higher second matching degree as an identification result of the first product and the second product.

9. The image analysis method according to claim 7, further comprising,
by the computer:
computing a second matching degree indicating a matching degree between the image region of the first product and an image region of a third product when the third product is present adjacent to the first product at a position different from the second product and has the identification result identical to that of the second product; and
correcting the identification result of the first product when the second matching degree is equal to or greater than a reference.

10. The image analysis method according to claim 6, further comprising,
by the computer:
acquiring information indicating an image region of a placement member that places a product; and
determining, as the first product and the second product, two products adjacent to each other in a direction orthogonal to the placement member without the placement member being interposed therebetween.

11. A non-transitory computer-readable medium storing a program for causing a computer to perform operations comprising:
acquiring an identification result of each of a plurality of products captured in an image;
computing a first matching degree being a matching degree between an image region of a first product among the plurality of products and an image region of a second product adjacent to the first product when the identification result of the first product differs from the identification result of the second product; and
assessing correction necessity of the identification result of the first product or the identification result of the second product, based on the first matching degree.
